(19) United States
(12) Patent Application Publication
(10) Pub. No.: US 2008/0158136 A1
(43) Pub. Date: Jul. 3, 2008

(54) LIQUID CRYSTAL DISPLAY APPARATUS

(76) Inventor: Harutoshi KANEDA, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/962,152

(22) Filed: Dec. 21, 2007

(30) Foreign Application Priority Data
Dec. 27, 2006 (JP) 2006-353263

(51) Int. Cl. G02F 1/13357

(52) U.S. Cl. 345/102

(57) ABSTRACT

A liquid crystal display apparatus includes a liquid crystal display panel, a backlight configured to illuminate the liquid crystal display panel, and a control unit configured to control the liquid crystal display panel and the backlight, wherein the control unit controls the backlight to shift to a predetermined luminance after a lighting state is stable after the turning-on of the power, and controls the liquid crystal display panel to perform a black display until the shift to the predetermined luminance is completed.

### CROSS-REFERENCE TO RELATED APPLICATIONS

This application is based upon and claims the benefit of priority from prior Japanese Patent Application No. 2006-353263, filed Dec. 27, 2006, the entire contents of which are incorporated herein by reference.

### BACKGROUND OF THE INVENTION

1. Field of the Invention

The present invention relates to a liquid crystal display apparatus in which a liquid crystal display panel is illuminated by a discharge lamp light source, and more particularly, to a liquid crystal display apparatus in which the luminance of the discharge lamp light source is adjusted after turning-on the power.

2. Description of the Related Art

A flat-panel display device represented by a liquid crystal display apparatus is widely utilized a s a display apparatus of a personal computer, information mobile terminal, television set, car navigation system, and the like.

The liquid crystal display apparatus generally comprises a display panel including a matrix array of a plurality of liquid crystal pixels, a backlight for illuminating the display panel, and a display control circuit for controlling the display panel and the backlight. A typical display panel has a structure in which a liquid crystal layer is held between an array substrate and a counter-substrate.

The array substrate has a plurality of pixel electrodes arranged in a matrix form, and the counter-substrate has common electrodes opposed to the pixel electrodes. The pixel electrodes and the common electrodes constitute liquid crystal pixels together with a pixel region of a liquid crystal layer arranged between these electrodes, and control a liquid crystal molecular arrangement by an electric field between the pixel electrode and the common electrode. In the display control circuit, digital display signals for the pixels are converted into pixel voltages by selectively using a predetermined number of reference gradation voltages, and output to the display panel. The pixel voltage is a voltage applied to the pixel electrode using the potential of the common electrode as a reference.

As the backlight described above, for example, a cold-cathode fluorescent lamp is used. This cold cathode fluorescent lamp is generally driven by an alternating lighting voltage applied thereto by using an inverter (Jpn. Pat. Appln. KOKAI Publication No. 10-90647).

Incidentally, as an experience in a case where a display panel is used in a dark environment, the screen is often felt to be excessively bright. The reason for this is that the display panel is illuminated by a backlight of a luminance that fits the surrounding brightness obtained in a normal environment. When the display panel is mounted on a vehicle as, for example, a part of a car navigation system, and is used at night while the vehicle is running, it is required to suppress the brightness of the screen to such a degree that the driving of the vehicle is not hindered.

However, even when the liquid crystal display apparatus has a structure in which the luminance of a backlight is adjusted so as to suppress the brightness of the screen in a dark environment, the following problem is caused immediately after turning-on the power.

When the power source voltage of the liquid crystal display apparatus is raised to a predetermined value and stabilized by the turning-on of the power, the display panel starts a display operation as shown in FIG. 7, and subsequently, the backlight is lit by an alternating lighting voltage output from an inverter on a predetermined cycle. The duty ratio of the alternating lighting voltage to the predetermined cycle is initially set large by the control of a pulse width modulation signal (PWM), and is changed to a small value after a stable discharge state of the backlight is assured. Such control is needed to prevent a malfunction such as a lighting delay or lighting failure, which may occur after the backlight is kept in an off state (shutoff state) for a long period of time from occurring, and light the backlight quickly and reliably. That is, immediately after the power is turned on, light dimming for suppressing the brightness of the screen of the display panel cannot be sufficiently effected.

For such a reason, when the power of the liquid crystal display apparatus is turned on, the entire screen of the display panel instantaneously shines brightly, and then shifts to a display state in which the dimming is effected. So as not to hinder driving the vehicle, this phenomenon should be prevented from occurring, and the brightness of the screen should therefore be suppressed as soon as possible.

### BRIEF SUMMARY OF THE INVENTION

A liquid crystal display apparatus according to a first aspect of the present invention comprises: a liquid crystal display panel; a backlight configured to illuminate the liquid crystal display panel; and a control unit configured to control the liquid crystal display panel and the backlight, wherein the control unit controls the backlight to shift to a predetermined luminance after a lighting state is stable after the turning-on of the power, and controls the liquid crystal display panel to perform a black display until the shift to the predetermined luminance is completed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing a liquid crystal display apparatus according to a first embodiment of the present invention.

FIG. 2 is a view schematically showing the configuration of a source driver shown in FIG. 1.

FIG. 3 is a view showing flows of signals generated after turning-on the power in the liquid crystal display apparatus shown in FIG. 1.

FIG. 4 is a chart showing timings of operations performed after the power is turned on in the liquid crystal display apparatus shown in FIG. 1.

FIG. 5 is a graph showing a luminance (transmittance) characteristic of the liquid crystal display panel shown in FIG. 1.

FIG. 6 is a view showing an example in which a liquid crystal drive voltage is increased by ΔV shown in FIG. 5.

FIG. 7 is a chart showing timings of operations performed after turning-on the power in a conventional liquid crystal display apparatus.

### DETAILED DESCRIPTION OF THE INVENTION

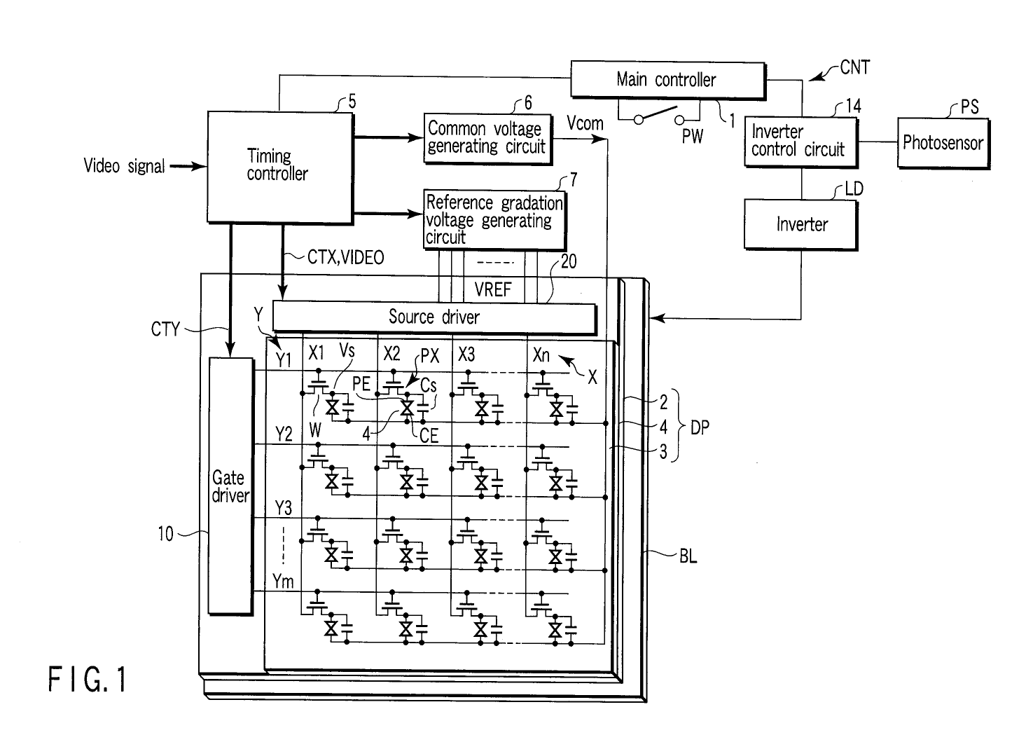

A liquid crystal display apparatus according to an embodiment of the present invention will be described below with reference to the accompanying drawings. FIG. 1 is a view schematically showing a circuit configuration of the liquid crystal display apparatus. The liquid crystal display apparatus comprises a liquid crystal display panel DP including a plurality of liquid crystal pixels PX, a backlight BL, which is a lamp light source using, for example, a discharge lamp, and is used to illuminate the liquid crystal display panel DP, and a control unit CNT for controlling the display panel DP and the backlight BL. The display panel DP has a structure in which a liquid crystal layer 4 is held between an array substrate 2 and a counter-substrate 3, and operates in a normally-white mode.

The array substrate 2 includes a plurality of pixel electrodes PE, a plurality of gate lines Y (Y1 to Ym), a plurality of source lines X (X1 to Xn), pixel switching elements W, a gate driver 10, and a source driver 20.

The pixel electrodes PE are arranged in a matrix form on a transparent insulating substrate such as a glass plate or the like. The gate lines Y (Y1 to Ym) are arranged along rows of the plural pixel electrodes PE. The source lines X (X1 to Xn) are arranged along columns of the plural pixel electrodes PE. The pixel switching elements W are arranged in the vicinities of intersection positions at which the gate lines Y and the source lines X intersect one another. The gate driver 10 drives the plural gate lines Y in sequence at a rate of one line in one horizontal display period. The source driver 20 drives the plural source lines X while each gate line Y is driven.

Each of the pixel switching elements W is constituted of, for example, a polysilicon thin film transistor. In this case, a gate of the thin film transistor is connected to one gate line Y, and a source to drain path is connected to one source line X and one pixel electrode PE. Incidentally, the gate driver 10 is constituted by using a polysilicon thin film transistor formed simultaneously with the pixel switching element W in the same step as the step in which the pixel switching element W is formed. Further, the source driver 20 is an integrated circuit (IC) chip mounted on the array substrate 2 by the COG (chip on glass) technique.

The counter-substrate 3 includes a color filter (not shown) arranged on a transparent insulating substrate such as a glass plate, the common electrodes CE being arranged on the color filter so as to be opposed to the plural pixel electrodes PE, and the like.

Each pixel electrode PE and each common electrode CE are constituted of a transparent electrode material such as ITO and the like. Between the pixel electrode PE and the common electrode CE, a liquid crystal layer 4 controlled by a liquid crystal molecular arrangement corresponding to an electric field from the electrodes PE and CE is arranged. The electrodes PE and CE constitute liquid crystal pixels PX together with the pixel region of the liquid crystal layer 4.

Further, all the pixels X each have storage capacitance Cs. The storage capacitance Cs in each of all the pixels is obtained by electrically connecting a plurality of storage capacitance lines respectively capacity-coupled to a plurality of pixel electrodes PE to the common electrodes CE on the array substrate 2 side.

The control unit CNT includes the gate driver 10 and the source driver 20 which are provided on the liquid display panel DP, and further includes a main controller 1, a timing controller 5, a common voltage generating circuit 6, a reference gradation voltage generating circuit 7, an inverter control circuit 14, and an inverter LD.

The main controller 1 controls the timing controller 5 and the inverter control circuit 14 upon supply of power performed by an operation of the power switch PW. The inverter control circuit 14 outputs a pulse width modulated signal (PWM) of a duty ratio set with respect to a predetermined period by the control of the main controller 1 to the inverter LD. The inverter LD outputs an alternating lighting voltage of a duty ratio coinciding with the duty ratio of the pulse width modulated signal to the backlight BL. The backlight BL is driven by this alternating lighting voltage so as to be lit.

The timing controller 5 controls the common voltage generating circuit 6, reference gradation voltage generating circuit 7, gate driver 10, and source driver 20 so as to display a digital video signal normally supplied from outside on the display panel DP as an image. The common voltage generating circuit 6 generates a common voltage V_{com} to the common electrodes CE on the counter-substrate 3. The reference gradation voltage generating circuit 7 generates reference gradation voltages VREF of a predetermined number. The reference gradation voltage VREF is used to convert a display signal of, for example, 6 bits obtained for each pixel PX from a video signal VIDEO into a pixel voltage V_{S}. The pixel voltage V_{S} is a voltage to be applied to the pixel electrode PE using the potential of the common electrode CE as the reference.

The timing controller 5 generates a control signal CTY for selecting a plurality of gate lines Y in sequence in each vertical scanning period, and a control signal CTX for allocating display signals for pixels PX for one line included in a video signal to a plurality of source lines X in each horizontal scanning period (1H). In this case, the control signal CTX includes a horizontal start signal STH, which is a pulse generated in each horizontal scanning period (1H), and a horizontal clock signal CKH, which is pulses of a number corresponding to the number of source lines generated in each horizontal scanning period. The control signal CTY is supplied from the timing controller 5 to the gate driver 10, and the control signal CTX is supplied from the timing controller 5 to the source driver 20 together with the digital video signal VIDEO.

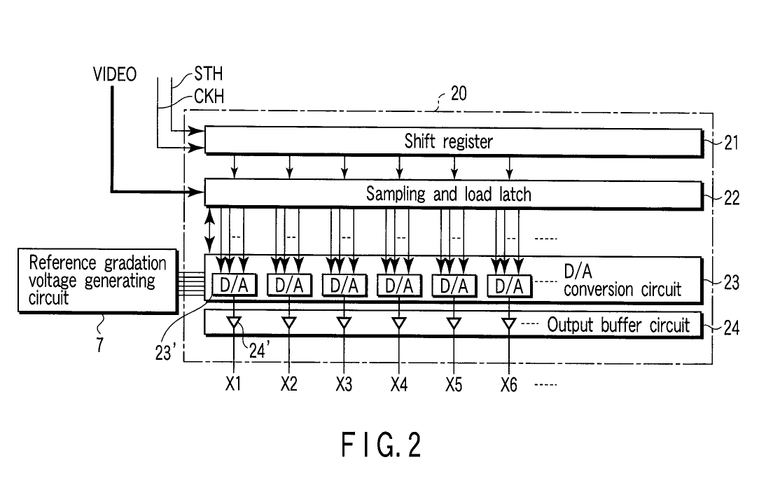

The gate driver 10 selects a plurality of gate lines Y in sequence by the control of the control signal CTY, and supplies a scanning signal for bringing the pixel switching element W into conduction to the selected gate line Y. In this embodiment, a plurality of pixels PX are brought into the selected state in sequence on a line-by-line basis in one horizontal scanning period. FIG. 2 is a view schematically showing the configuration of the source driver 20 shown in FIG. 1.

The source driver 20 includes a shift register 21, a sampling and load latch 22, a digital-to-analog (D/A) conversion circuit 23, and an output buffer circuit 24.

The shift register 21 shifts a horizontal start signal STH in synchronization with a horizontal clock signal CKH, and controls timings at which the digital video signals VIDEO are subjected to serial-parallel conversion in sequence. The sampling and load latch 22 latches the digital video signals VIDEO in sequence by the control of the shift register 21, and outputs them in parallel as display signals for pixels PX of one line. The digital-to-analog (D/A) conversion circuit 23 converts the display signals into analog pixel voltages V_{S}. The output buffer circuit 24 amplifies the analog pixel voltage V_{S} obtained from the D/A conversion circuit 23.

The D/A conversion circuit 23 is configured to refer to reference gradation voltages VREF of a predetermined number generated from the reference gradation voltage generating circuit 7.

The D/A conversion circuit 23 is constituted of, for example, a plurality of D/A conversion sections 23′ known as resistor DACs. Each D/A conversion section 23′ selects one of the reference gradation voltages VREF of the predetermined number on the basis of a digital display signal output from the sampling and load latch 22, and further converts the selected reference gradation voltage VREF into a pixel voltage V_{S} by a potentiometric method. The output buffer circuit 24 is constituted of a plurality of buffer amplifiers 24′ for outputting pixel voltages V_{S} from the plural D/A conversion sections 23′ to source lines X1, X2, X3.

In this liquid crystal display apparatus, the source driver 20 converts the display signals for pixels PX of one line included in the digital video signal into pixel voltages V_{S}, and outputs the pixel voltages V_{S} to the source lines X1 to Xn in each horizontal scanning period in which the gate driver 10 outputs a scanning signal to one gate line Y. The pixel voltages V_{S} on the source lines X1 to Xn are respectively supplied to corresponding pixel electrodes PE through pixel switching elements W for one line driven by the scanning signal.

The common voltage V_{com} is output from the common voltage generating circuit 6 to the common electrode CE in synchronization with an output timing of the pixel voltage V_{S}. This common voltage generating circuit 6 is constituted by using a D/A converter or the like for generating an output voltage corresponding to numerical data of, for example, about 8 to 10 bits set by the timing controller 5, and alternately outputs a voltage of 0V or 5.8V in each horizontal scanning period. Accordingly, on the source driver 20 side, each D/A conversion section 23′ inverts the level of the pixel voltage V_{S} by using the center level of the common voltage V_{com} as the reference. When the liquid crystal drive voltage, which is a potential difference between the pixel electrode PE and the common electrode CE, is to be maximized, the pixel voltage V_{S} is set to 5.8V with respect to a common voltage V_{com} of 0V, and is set to 0V with respect to a common voltage V_{com} of 5.8V.

Incidentally, although the pixel voltage V_{S} is output from the source driver 20 at 5.8V, the pixel voltage is reduced to, for example, 4.8V by a field through voltage resulting from a parasitic capacity of the pixel switching element W, and is held at this value at the pixel electrode PE. For this reason, the amplitude and the center level of the common voltage V_{com} output from the common voltage generating circuit 6 are adjusted in advance in accordance with the pixel voltage V_{S} actually held at the pixel electrode PE.

The above-mentioned control unit CNT is configured in such a manner that the backlight BL is lit so as to allow it to shift to the predetermined luminance after a stable lighting state is assured after the turning-on of the power of the liquid crystal display apparatus, and the liquid crystal display panel DP is caused to perform a black display until the shift to the predetermined luminance of the backlight is completed. More specifically, after the turning-on of the power, while the common voltage V_{com} is applied to the common electrodes CE as the reference potential, the pixel voltage V_{S} for causing the black display to be performed by the potential difference between itself and the reference potential is applied to a plurality of pixel electrodes PE.

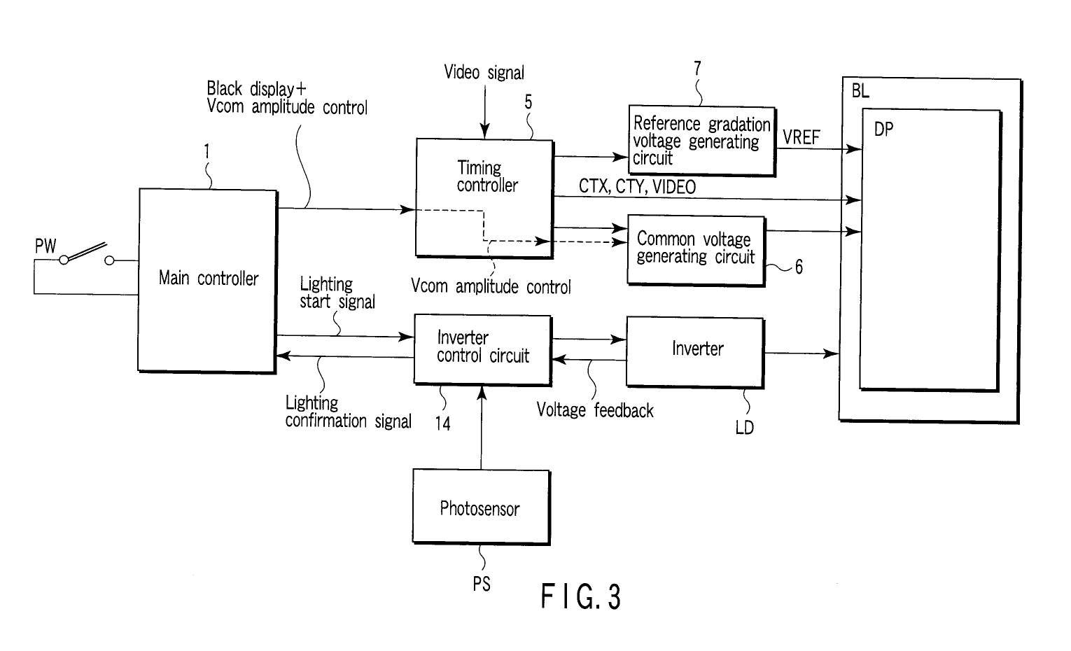

FIG. 3 shows flows of signals generated in the control unit CNT after the turning-on of the power. The main controller 1 performs black display control after the power source voltage rises upon supply of the power, and is stably set at a predetermined value. In this black display control, a video signal for the black display is output to the timing controller 5 together with a control signal for outputting the video signal for the black display in place of an externally supplied video signal VIDEO. As a result, the timing controller 5 outputs the black display video signal to the source driver 20 on the display panel DP, and controls the common voltage generating circuit 6, reference gradation voltage generating circuit 7, gate driver 10, and source driver 20 in such a manner that liquid crystal pixels PX of each row perform the black display in accordance with the black display video signal.

Further, the main controller 1 outputs a lighting start signal to the inverter control circuit 14 at the start of the black display control. In response to this lighting start signal, the inverter control circuit 14 outputs a pulse width modulation signal (PWM), in which a duty ratio is set at 100%, to the inverter LD. The inverter LD drives the backlight BL by an alternating lighting voltage in which a duty ratio of 100% coinciding with the duty ratio of the pulse width modulation signal is set. The inverter control circuit 14 confirms that a stable lighting state of the backlight BL has been assured on the basis of the alternating lighting voltage fed back thereto through the inverter LD, outputs a lighting confirmation signal to the main controller 1, and changes the duty ratio of the pulse width modulation signal so as to cause the luminance of the backlight BL to conform to the brightness sensed by a photosensor PS. For example, in a dark environment such as the inside of a vehicle at night, the duty ratio of the pulse width modulation signal is changed to a value less than 100% in accordance with a sensing result of the photosensor PS. As a result, the inverter LD drives the backlight BL by an alternating lighting voltage having a duty ratio less than 100% coinciding with the duty ratio of the pulse width modulation signal, and reduces the luminance of the backlight BL so as to suppress the brightness of the screen of the liquid crystal display panel to such a degree that the driving of the vehicle is not hindered. On the other hand, the main controller 1 receives the lighting confirmation signal output from the inverter control circuit 14, and thereafter outputs a control signal for causing a video signal VIDEO from outside to be output in place of the black display video signal to the timing controller 5, thereby terminating the black display control. The timing at which the externally supplied video signal VIDEO is output from the timing controller 5 in place of the black display video signal is determined in such a manner that the timing is delayed from generation of the lighting confirmation signal by at least a transition time of the backlight BL required to shift the maximum luminance to the predetermined luminance. As a result, the timing controller 5 outputs the video signal VIDEO supplied from outside to the source driver 20 on the display panel DP, and controls the common voltage generating circuit 6, reference gradation voltage generating circuit 7, gate driver 10, and source driver 20 in such a manner that liquid crystal pixels PX of each row perform the normal display in accordance with the video signal VIDEO after the luminance transition of the backlight BL.

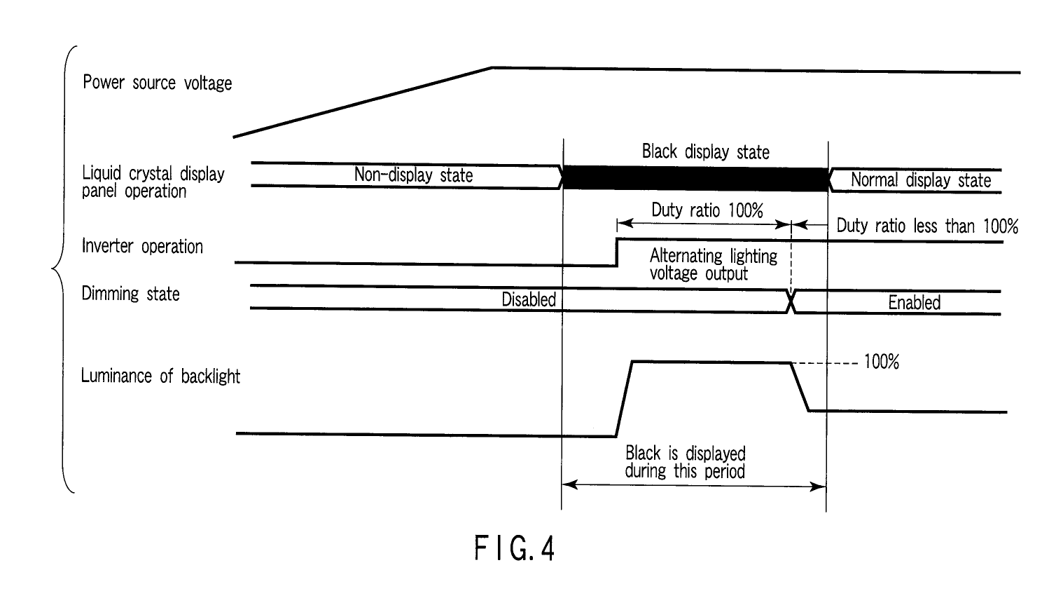

FIG. 4 shows timings of operations performed after the turning-on of the power in the liquid crystal display apparatus described above.

When the control unit CNT is configured as described above, the liquid crystal display apparatus operates as shown in FIG. 4. The liquid crystal display panel DP is in the non-display state until the black display control is started after the turning-on of the power. When the black display control is started, the non-display is shifted to the black display state where the black display is performed.

While the display panel DP is in the black display state, when the inverter LD drives the backlight BL by an alternating lighting voltage having a duty ratio of 100%, the backlight BL is lit. Further, when it is confirmed that the luminance of the backlight BL has been raised to approximately the maximum, and is in a stable lighting state, the duty ratio of the alternating lighting voltage output from the inverter LD is changed, whereby the backlight BL is shifted to the predetermined luminance suited to the brightness of the surroundings of the display panel DP. That is, the dimming for suppressing the brightness of the screen of the display panel DP in a dark environment is disabled from immediately after the turning-on of the power until the stable lighting state is assured, and is enabled after the stable lighting state is assured. The black display state of the display panel DP is continued at least until the transition to the predetermined luminance is completed. When the transition to the predetermined luminance is actually completed, the display panel DP is in a state where the display panel performs the normal display corresponding to the video signal VIDEO supplied from outside.

According to this embodiment, the black display state of the display panel DP is continued at least until the transition to the predetermined luminance is completed. Accordingly, even if the backlight BL temporarily emits light at a high luminance, the phenomenon of high luminance of the display of the display panel DP does not occur.

Incidentally, the present invention is not limited to the embodiment described above as it is and, in the implementation stage, the constituent elements may be modified and concretized within the scope not deviating from the gist of the invention. Further, by appropriately combining a plurality of constituent elements disclosed in the above-mentioned embodiment, various inventions can be formed. For example, some constituent elements may be deleted from the entire constituent elements shown in the embodiment. Further, constituent elements of different embodiments may be appropriately combined.

Incidentally, in the black display control in the embodiment described above, the apparatus is configured in such a manner that the main controller 1 and the timing controller 5 supply the black display video signal to the source driver 20. As a first modification example, the apparatus may be configured in such a manner that in the black display control, the main controller 1 and the timing controller 5 switch, for example, all the reference gradation voltages VREF of the predetermined number output from the reference gradation voltage generating circuit 7 to the pixel voltages V_{S} for the black display. In this manner too, the black display can be performed entirely on the screen of the liquid crystal display panel DP.

Further, as a second modification example, the apparatus may be configured in such a manner that in the black display control, the main controller 1 and the timing controller 5 shift the common voltage V_{com} supplied from the common voltage generating circuit 6 in order to further dim the screen, in addition to the utilization of the pixel voltage V_{S} for the black display.

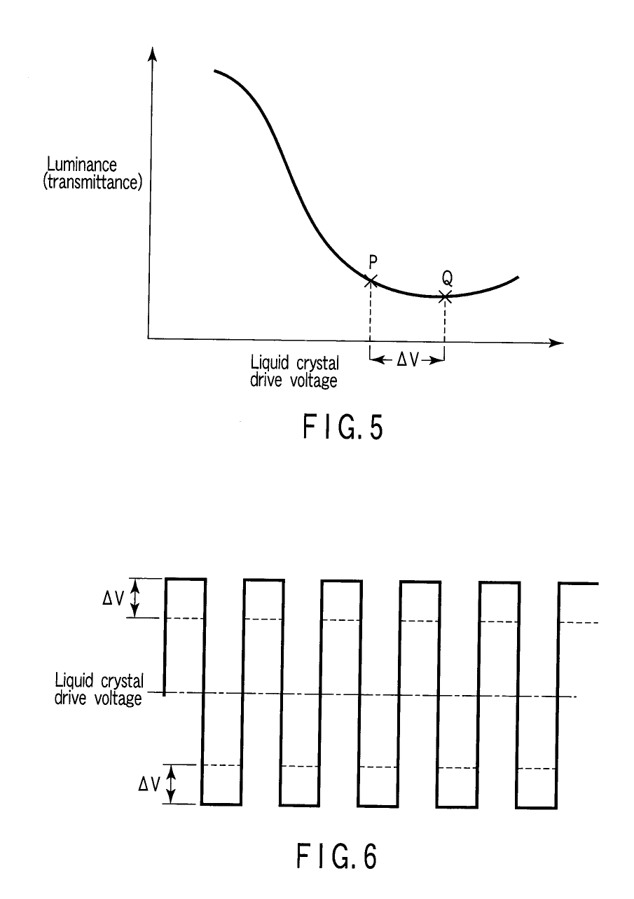

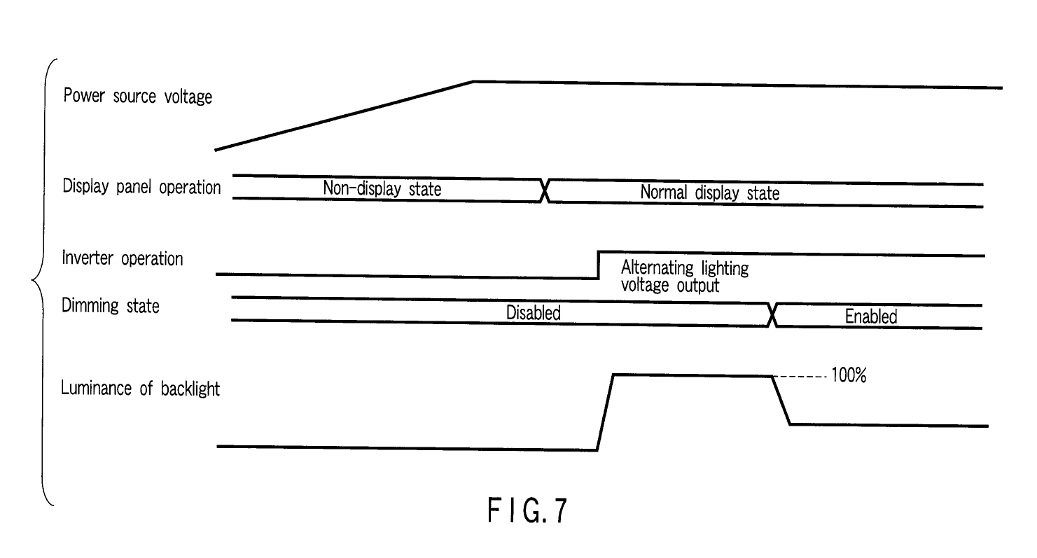

FIG. 5 shows the luminance versus liquid crystal drive voltage characteristic of the liquid crystal display panel DP. As shown in FIG. 5, as the liquid crystal drive voltage increases, the luminance lowers, and the luminance becomes the minimum at the point Q. Thereafter, as the liquid crystal drive voltage increases, the luminance increases a little on the contrary.

Incidentally, normally, at the time of the black display, the liquid crystal drive voltage is set at a voltage value at a point P smaller than the voltage value at the point Q by ΔV. Accordingly, by shifting the common voltage V_{com} in the black display control, and increasing the liquid crystal drive voltage by ΔV as shown in FIG. 6, the luminance of the black display can be lowered from the point P to the point Q, whereby a darker black display state can be obtained.

The control of the reference gradation voltage VREF as described in the first modification example and the control of the common voltage V_{com} as described in the second modification example can be arbitrarily combined with each other.

Further, the present invention is not limited to the liquid crystal of the TN mode and the OCB mode, and can be widely applied to the general liquid crystal display apparatuses.

Furthermore, the apparatus may be configured in such a manner that the inverter control circuit 14 receives, instead of receiving the sensing result from the photosensor PS, information on the brightness of the surroundings of the liquid crystal display panel DP supplied from the outside of, for example, a car navigation system main body or the like, and shifts the luminance of the backlight BL in such a manner that the luminance of the backlight BL is suited to the brightness obtained from the information when the black display control is terminated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display apparatus comprising:
a liquid crystal display panel;
a backlight configured to illuminate the liquid crystal display panel; and
a control unit configured to control the liquid crystal display panel and the backlight,
wherein the control unit controls the backlight to shift to a predetermined luminance after a lighting state is stable after the turning-on of the power, and controls the liquid crystal display panel to perform a black display until the shift to the predetermined luminance is completed.

2. The liquid crystal display apparatus according to claim 1,
wherein the liquid crystal display panel includes a first substrate having a plurality of pixel electrodes, a second substrate having common electrodes opposed to the plural pixel electrodes, and a liquid crystal layer held between the first and second substrates, and
the control unit applies a common voltage to the common electrodes as a reference potential upon supply of power, and applies a pixel voltage to perform the black display by a potential difference between the pixel voltage and the reference potential to the plural pixel electrodes.

3. The liquid crystal display apparatus according to claim 2,
wherein the control unit is further configured to shifts the common voltage to a value that increases the potential difference between the plural pixel electrodes and the common electrodes.

4. The liquid crystal display apparatus according to claim 1,
wherein the control unit includes an inverter which outputs an alternating lighting voltage to a lamp light source of the backlight on a predetermined cycle, and an inverter control circuit which controls a duty ratio of the alternating lighting voltage to the predetermined cycle, and
the inverter control circuit confirms that a stable lighting state of the lamp light source is assured on the basis of the alternating lighting voltage fed back thereto from the lamp light source through the inverter.

5. The liquid crystal display apparatus according to claim 4,
wherein the predetermined luminance has a value suited to the brightness of the surroundings of the liquid crystal display panel.

6. The liquid crystal display apparatus according to claim 1,
wherein the control unit controls a reference gradation voltage generating circuit, which generates a gradation voltage supplied to the liquid crystal display panel, to perform a black display on the liquid crystal display panel until the shift to the predetermined luminance is completed.
